(19) United States
(12) Patent Application Publication
(10) Pub. No.: US 2011/0196803 A1
(43) Pub. Date: Aug. 11, 2011

(54) TECHNIQUES FOR MAPPING COURSES TO PROGRAM REQUIREMENTS

(76) Inventors: John Reynolds, Tempe, AZ (US); Kurt R. Schedler, Chandler, AZ (US); Sachin Garg, Laveen, AZ (US); Balaji Gandhi, Chandler, AZ (US); Christopher P. Gray, Prairie Village, KS (US)

(21) Appl. No.: 12/701,480

(22) Filed: Feb. 5, 2010

(51) Int. Cl. G06Q 50/00; G06Q 10/00

(52) U.S. Cl. 705/327

(57) ABSTRACT

An evaluation of an external course may be based on course-to-requirement mappings that have been previously established for the target institution. As a result of the evaluation, the external course may be mapped to a particular program requirement for a particular student, which allows the external course to fulfill the particular program requirement at the institution for the particular student. The course evaluation may be automatic or may be performed by a human evaluator. Course-to-requirement mappings may be globally-established, and applicable to all students and applicants of the target institution, or may be applicant-specific, and only applicable to the student for which the mapping was established. Information about both globally-established and applicant-specific course-to-requirement mappings that have been previously established for the institution may be used to evaluate an external course for a particular student.

### FIELD OF THE INVENTION

The present invention relates to establishing course-to-requirement mappings and, more specifically, to mapping a course offered by a first institution to a program requirement of a second institution.

### BACKGROUND

To obtain academic recognition (e.g., an academic degree, professional certificate, etc., hereafter referred to as a “degree” for simplicity) at an institution, such as at a college or university, a student must fulfill the requirements that have been set by the institution for the program associated with the degree. For example, an institution may require that a student take and pass certain courses prescribed by the institution as prerequisites to receiving a particular degree from the institution. Generally, once the student has fulfilled all of the requirements of the degree program, the student receives the associated degree from the institution.

Many times, a student begins taking courses for a particular degree program at one institution and, before finishing all of the requirements for the program, transfers to another institution. As part of the transfer process, the student may request that the new institution evaluate any courses that the student has taken at other institutions to determine how to apply the courses to the requirements of the new institution. Thus, courses taken at a prior institution may fulfill program requirements at the new institution, which lessens the number of requirements remaining at the new institution for the student to obtain a degree.

However, it may be difficult for a particular institution (a “target institution”) to map courses offered by other institutions (“source institutions”) to program requirements at the target institution. One way to evaluate courses offered by a source institution is to evaluate each course of the source institution by hand. To evaluate a course by hand, a human evaluator for the target institution reviews the content of the course to determine how to apply the course to requirements at the target institution. An evaluator for a target institution may refer to several sources of information on the course. For example, an articulation agreement, between the target institution and the source institution, may provide guidance on mapping the course to one or more program requirements at the target institution. Also, course catalogs provided by the source institution may contain information to aid in evaluating the course.

Evaluating courses by hand may be expensive given the time required to study the course's content and to map that content to an appropriate program requirement. Furthermore, the expense of evaluating courses by hand may increase if a target institution evaluates courses that have been taken by both matriculating students and students who are merely interested in knowing how the courses that they have previously taken would apply to programs at the target institution. This expense is compounded by the fact that many of the students, which are merely interested in seeing what requirements at a target institution would be fulfilled by courses that the students have taken at other institutions, do not actually transfer to the target institution.

It would be beneficial to provide more information to a human evaluator for a target institution to decrease the time it takes to evaluate courses from source institutions. Also, it would be beneficial to automatically evaluate courses from the source institutions to determine how the courses map to program requirements at the target institution.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts an example network arrangement 100 for evaluating courses.

FIG. 2 illustrates an instance of a database that includes both globally-established and applicant-specific course-to-requirement mappings.

FIG. 3 illustrates an example method of using previously-established course-to-requirement mappings to determine a mapping for a particular external course to one or more requirements of a particular internal program for a particular student.

FIG. 4 illustrates an example graphical user interface to display a hypothetical student's progress in a program based on the course-to-requirement mappings that have been established for the student's external coursework.

FIG. 5 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein in which a course evaluator automatically determines, for a target institution, course-to-requirement mappings for courses that are offered by source institutions (referred to herein as “external courses”). Techniques are also described in which a course evaluator facilitates the manual evaluation of an external course by providing information about course-to-requirement mappings that have been previously associated with the external course.

Evaluation of the external course may be based on course-to-requirement mappings that have been previously established for the target institution. These mappings may be globally-established, and applicable to all students and applicants of the target institution, or may be applicant-specific, and only applicable to the student for which the mapping was established. Information about both globally-established and applicant-specific course-to-requirement mappings that have been previously established for the target institution may be used to evaluate an external course for a particular student. As a result of the evaluation, the external course may be mapped to a particular program requirement for the particular student, which allows the external course to fulfill the particular program requirement at the target institution.

### Course Evaluation Architecture

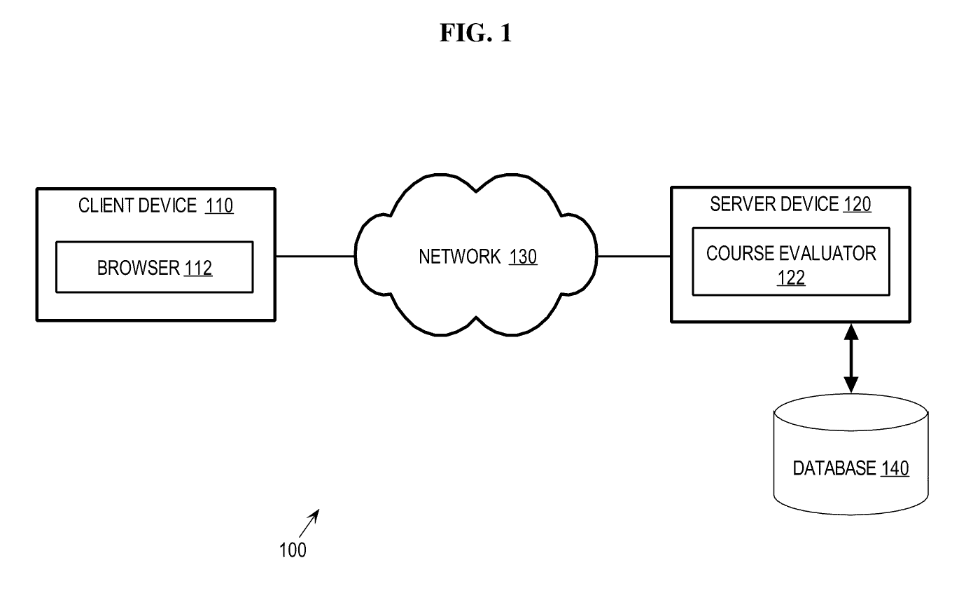

An example course evaluator may reside on a server and evaluate, or facilitate the evaluation of, external courses that are submitted to the course evaluator over a network. Determining possible course-to-requirement mappings for an external course is referred to herein as “evaluating” the external course. FIG. 1 is a block diagram that depicts an example network arrangement 100 for evaluating external courses, according to embodiments of the invention. Network arrangement 100 includes a client device 110, and a server device 120, communicatively coupled via a network 130. Server device 120 is also communicatively coupled to a database 140.

Client device 110 may be implemented by any type of client device. Example implementations of client device 110 include, without limitation, workstations, personal computers, laptop computers, personal digital assistants (PDAs), cellular telephony devices, and any type of mobile devices. In network arrangement 100, client device 110 is configured with a browser 112. Browser 112 is configured to interpret and display web pages received over network 130, such as Hyper Text Markup Language (HTML) pages, and Extensible Markup Language (XML) pages, etc. Browser 112 may also be configured to facilitate other kinds of communication between client device 110 and server device 120 over network 130. In an alternative embodiment, client device 110 is configured without browser 112. Client device 110 may also be configured with other mechanisms, processes, and functionality, depending upon a particular implementation.

Network 130 may be implemented with any type of medium and/or mechanism that facilitates the exchange of information between client device 110 and server device 120. Furthermore, network 130 may use any type of communications protocol, and may be secured or unsecured, depending upon the requirements of a particular application.

Server device 120 may be implemented by any type of device that is capable of communicating with client device 110 over network 130. In network arrangement 100, server device 120 is configured with course evaluator 122. Course evaluator 122 is capable of producing web pages to be sent over network 130 to client device 110. Course evaluator 122 is further configured to receive information, including documents, over network 130, e.g., through HyperText Transfer Protocol (HTTP), HyperText Transfer Protocol Secure (HTTPS), File Transfer Protocol (FTP), etc. Course evaluator 122 may be implemented by one or more logical modules within the embodiments of the invention, and is described in further detail below. Server device 120 may be configured with other mechanisms, processes and functionalities, depending upon a particular implementation.

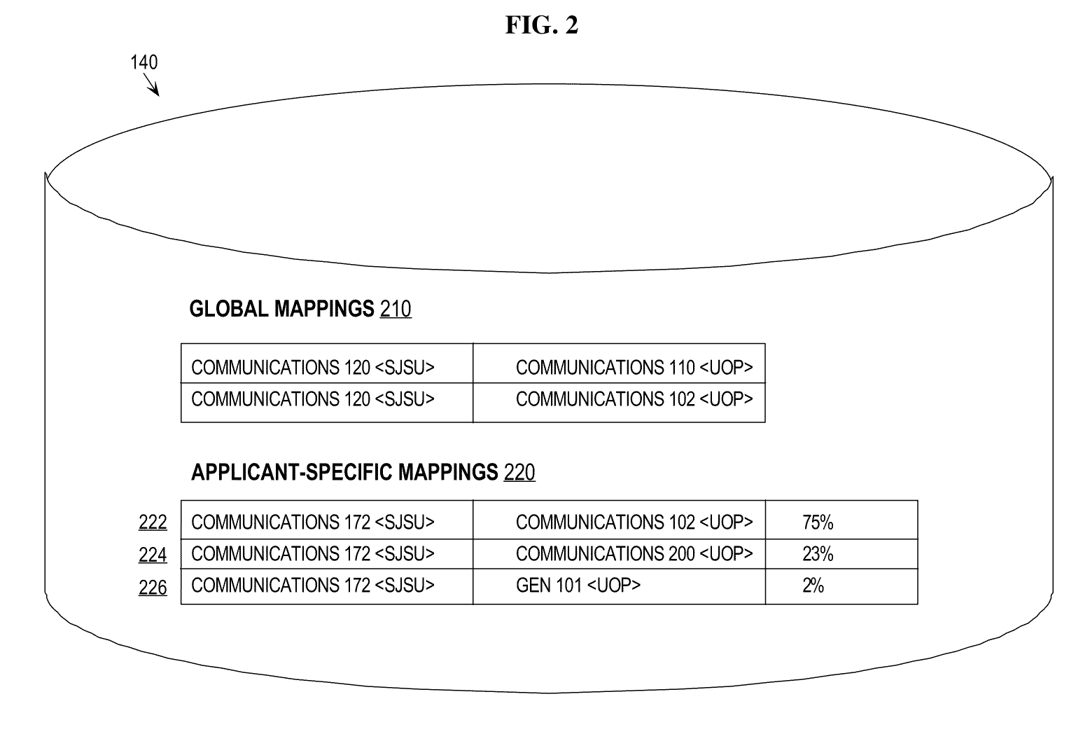

Server device 120 is communicatively coupled to database 140. Database 140 may be implemented by any type of storage, including volatile and non-volatile storage. Database 140 may include, without limitation, random access memory (RAM), one or more hard or floppy disks, or main memory. Database 140 may comprise one or more modules that are external to server device 120, or may be implemented as an internal component of server device 120. Furthermore, database 140 may not be directly connected to server device 120, but may be accessible to server device 120 over network 130. In one embodiment of the invention, database 140 stores information about globally-defined and applicant-specific course-to-requirement mappings, described in further detail below, which are utilized by course evaluator 122. FIG. 2 illustrates an instance of database 140 that includes global mappings 210 and applicant-specific mappings 220.

Thus, in the embodiment illustrated in FIG. 1, a user of client device 110 may request from course evaluator 122 a web page, where the web page has controls that allow the user to specify information about an external course. Course evaluator 122 may send the requested web page to client device 110, over network 130. Course evaluator 122 may receive the information about the course that the user submits through the web page, and then may evaluate the course based on the received information. The evaluation of the course may be based, at least in part, on course-to-requirement mappings stored at database 140. Course evaluator 122 may indicate the results of the course evaluation to the user of client device 110, e.g., by returning a web page that includes a display of the results to client device 110, or by sending an email containing the results to the user, etc.

### Course-to-Requirement Mappings

As previously stated, courses offered by a source institution may be evaluated to determine possible mappings between the course and the program requirements of the target institution. Such an evaluation may be based on course-to-requirement mappings that have been previously performed for the target institution, which may be stored in database 140.

Some institutions have many programs, each of which may have a different set of requirements. For example, an institution may have one program designed to satisfy requirements for a Bachelor of Science degree in Communications, and another program designed to satisfy the requirements for a Bachelor of Science degree in Computer Science. Collectively, the set of requirements of all programs of a target institution are referred to herein as the “internal requirements” of the target institution. Typically, a program represents all requirements associated with any form of academic recognition conferred by a target institution. A form of academic recognition is a degree, or certificate, etc., in a particular field of study, e.g., a Bachelor of Science Degree in Communications.

As used herein, the term “course” refers to any kind of qualification that a target institution recognizes as fulfilling one or more requirements of the target institution. For example, the term “course” may refer to any kind of class recognized by the institution, whether or not the class is administered by the institution. A course that is offered by an institution may be a class taught on the campus of the institution and taught by institution faculty. Such a course may also be a class taught over the Internet or at a remote location by institution faculty. Furthermore, a course offered by an institution may be taught on a campus that is remote from the campus of the institution, or over the Internet, by a teacher that is not affiliated with the institution, which is recognized by the institution as eligible for course credit. For example, an institution may recognize that a certification program offered by a private company, which program is used to train people on the company's technology, is eligible for course credit.

Furthermore, a target institution may map other kinds of qualifications to requirements of the target institution. For example, a target institution may map a proficiency exam to one or more requirements of the target institution. A proficiency exam may be offered by a target or source institution, government entities, including various branches of the armed services, and other testing bodies. Thus, if an applicant passes the proficiency exam, the exam may be considered as fulfilling the requirement of the target institution to which the exam is mapped. A target institution may also map qualifications such as a professional license, or a published experiential essay, etc., to one or more requirements of the target institution.

An institution may have many different kinds of requirements to which an external course may be mapped. For example, an institution may map an external course to program requirements, such as (a) a particular course offered by the institution (an “internal course”); (b) course credit for a particular category of courses; (c) general course credit; (d) a non-course requirement of a program; or (e) nothing, etc.

To illustrate, an evaluator for a Target University may evaluate a three-credit course titled “Persuasive Speaking” offered by a Source University. That course shall be referred to herein as Comm 120 As a result of the evaluation, the evaluator may map Comm 120 to a particular course offered by Target University, such as Comm 110, titled “Introduction to Oral Communication”. The evaluator may also map Comm 120 by Source University to course credit for a particular category of courses, e.g., three Communications course credits, without mapping Comm 120 to a particular internal course. The evaluator may map Comm 120 to three general course credits, e.g., elective credits, without assigning the credits to any kind of course category. Furthermore, the evaluator may map Comm 120 to a non-course requirement of a Target University program, such as the performance of a public speech or passing a test for the program. Likewise, Target University may determine that Comm 120 by Source University does not map to any requirement of a Target University program.

For ease of explanation, course-to-requirement mappings are described herein as mapping external courses to internal courses. However, as indicated above, a course-to-requirement mapping may map an external course to institution requirements rather than to a specific an internal course.

Established course-to-requirement mappings may be stored in database 140 (FIG. 1). In one embodiment, the mappings stored in database 140 are generated based on human input, e.g., a human evaluator creates the mapping and causes the mapping to be stored in database 140. Further, a target institution may require that a mapping is stored in database 140 only if the mapping has been the basis of transfer of one or more students, i.e., has been applied to an external course taken by a student to allow the external course to fulfill a program requirement of the institution for the student. Similarly, a target institution may allow only binding mappings to be stored in database 140, as described in further detail below. In another embodiment, mappings that are automatically created, e.g., by course evaluator 122, are also stored in database 140.

### Global Course-to-Requirement Mappings

Certain course-to-requirement mappings that have been established for an institution may be applicable to all applicants and students of the institution. Such mappings are called “global course-to-requirement mappings” herein. Global course-to-requirement mappings may be established using many methods, including through articulation agreements, by a committee's detailed assessment of an external course, etc.

Articulation agreements are agreements that a target institution has made with another entity, such as another institution or company, that defines certain global course-to-requirement mappings. For example, to produce an articulation agreement between two institutions, representatives of the institutions may review courses and program requirements offered by each of the institutions and determine mappings between external courses and internal institutional requirements. Such articulation agreements are generally implemented as institution-wide policy for the parties to the agreement, and the course-to-requirement mappings defined therein may be applied to all students and applicants of an institution that is party to the agreement.

A global course-to-requirement mapping for an external course may also be created for an institution based on a detailed assessment of the external course. Such a detailed assessment may include a review of various aspects of the external course, which aspects may include the subject matter, requirements, level, and perceived difficulty, etc., of the external course. Based on the aspects of the external course, the course may be deemed appropriate to fulfill one or more program requirements of the institution for all applicants and students of the institution.

To illustrate global mappings, an articulation agreement between Source University and Target University indicates that Comm 120 offered by Source University maps to Comm 110 offered by Target University. Furthermore, an evaluator at Target University has made a detailed analysis of Comm 120 from Source University, and has determined that Comm 120 offered by Source University also maps to Comm 102 offered by Target University. Therefore, Comm 120 by Source University is globally mapped to both Comm 110 and Comm 102 offered by Target University. In one embodiment, both of the global mappings for Comm 120 by Source University are recorded in database 140, as illustrated by global mappings 210 in database 140 of FIG. 2.

### Applicant-Specific Course-to-Requirement Mappings

Not all external courses are associated with global course-to-requirement mappings at a target institution. In some cases, an applicant-specific course-to-requirement mapping may be established for an individual applicant or student of a program. In contrast to global course-to-requirement mappings, an applicant-specific mapping is only applicable to the individual student for which the mapping was created, and is not generally applicable to all applicants or students at the institution. Even when there is a global course-to-requirement mapping for a specific external course, an institution may allow an applicant to have an applicant-specific mapping for that external course that differs from a global course-to-requirement mapping. Obtaining an applicant-specific mapping for an external course that differs from the global course-to-requirement mapping for the same external course may be useful, for example, if the one or more program requirements to which the course is mapped in the global mapping are not requirements that the applicant needs for the program desired by the applicant.

An applicant-specific mapping may be established in any number of ways. For example, an applicant-specific mapping may be established by an assessment of an external course that is (a) less detailed than the assessment that results in a global mapping, or (b) done by an evaluator that does not have the training and/or authority to establish a global mapping for the external course. An applicant-specific course-to-requirement mapping may be stored in database 140, as illustrated by applicant-specific mappings 220 in database 140 of FIG. 2.

An evaluating institution may require certain standards for establishing an applicant-specific course-to-requirement mapping. For example, to be allowed to establish an applicant-specific mapping, an institution may require that evaluators have particular qualifications. Also, an institution may require that an evaluator review certain aspects of an external course and an internal program requirement in order to allow the external course to be applicant-specifically mapped to the internal program requirement.

### Binding and Non-Binding Mappings

An applicant-specific course-to-requirement mapping may be binding or non-binding. An applicant-specific course-to-requirement mapping is binding if the target institution commits itself to honor the mapping for the applicant for which the binding was created. An applicant-specific course-to-requirement mapping is non-binding if no such commitment is given by the target institution. For example, in the case of a student that is matriculating at an institution, one or more binding applicant-specific course-to-requirement mappings may be established to determine how the student's external coursework applies to the requirements of the institution. A particular mapping is binding on an institution when the particular mapping is established to serve as a basis for the transfer of a matriculating student.

For a student that is merely curious about how his or her external coursework would apply to requirements at the institution, non-binding applicant-specific course-to-requirement mappings may be established to allow the student to evaluate which requirements the external coursework would fulfill. A non-binding mapping is established for illustrative purposes only, and may not be used as a basis of transfer for a student.

For example, Student A, a person that is not yet a student at Target University, submits a transcript to Target University that includes courses taken from Source University. The transcript lists Comm 172, titled “Multicultural Communication in the United States”, for which no global course-to-requirement mappings have been established at Target University, as shown in global mappings 210 of FIG. 2. An evaluator at Target University reviews Comm 172 offered by Source University, and determines that the external course may map to Comm 102 offered by Target University. The evaluator may establish an applicant-specific course-to-requirement mapping that maps Comm 172 offered by Source University to Comm 102 offered by Target University, as illustrated by applicant-specific mapping 222 of FIG. 2. The resulting applicant-specific course-to-requirement mapping may be considered binding for Target University if the mapping, e.g., is presented to Student A as a non-illustrative mapping, or is established by a person with the authority to establish a binding mapping with the intent that the mapping be binding on Target University.

If the established mapping is binding, then Student A receives credit for Comm 102 at Target University based on the student's successful completion of Comm 172 at Source University because of the mapping. However, this applicant-specific course-to-requirement mapping does not allow any other student to receive credit for Comm 102 at Target University based on successful completion of Comm 172 at Source University. To be applied to a particular student, an applicant-specific course-to-requirement mapping must be made for the particular student individually.

### Inconsistent Applicant-Specific Mappings

For any given external course, the applicant-specific mapping of one applicant may be different than the applicant-specific mapping for another applicant. Thus, when an applicant-specific mapping is established and recorded in database 140, the mapping is recorded individually in conjunction with an identifier of the student for which the applicant-specific mapping was established. Thus, for some students, Comm 172 may map to one course, while for other students Comm 172 maps to other courses.

Referring to FIG. 2, inconsistent applicant-specific mappings 220 for Comm 172 are illustrated in summary form. Specifically, applicant-specific mappings 220 include mapping 222, which indicates that Comm 172 by Source University has been mapped to Comm 102 by Target University. Mapping 222 further indicates that 75% of the applicant-specific mappings 220 that map Comm 172 by Source University to a program requirement at Target University constitute the mapping described in mapping 222.

Similarly, mapping 224 indicates that 23% of the mappings for Comm 172 by Source University map the external course to Comm 200 by Target University. Mapping 226 indicates that 2% of the mappings for Comm 172 map the external course to General Education 101 (“GEN 101”) by Target University. These percentages only account for those applicant-specific mappings 220 that map Comm 172 by Source University to a Target University program requirement. Within database 140, there may be any number of applicant-specific mappings 220 that do not involve Comm 172 by Source University, which are not illustrated in FIG. 2.

### Using Applicant-Specific Mappings to Determine a Mapping for an External Course

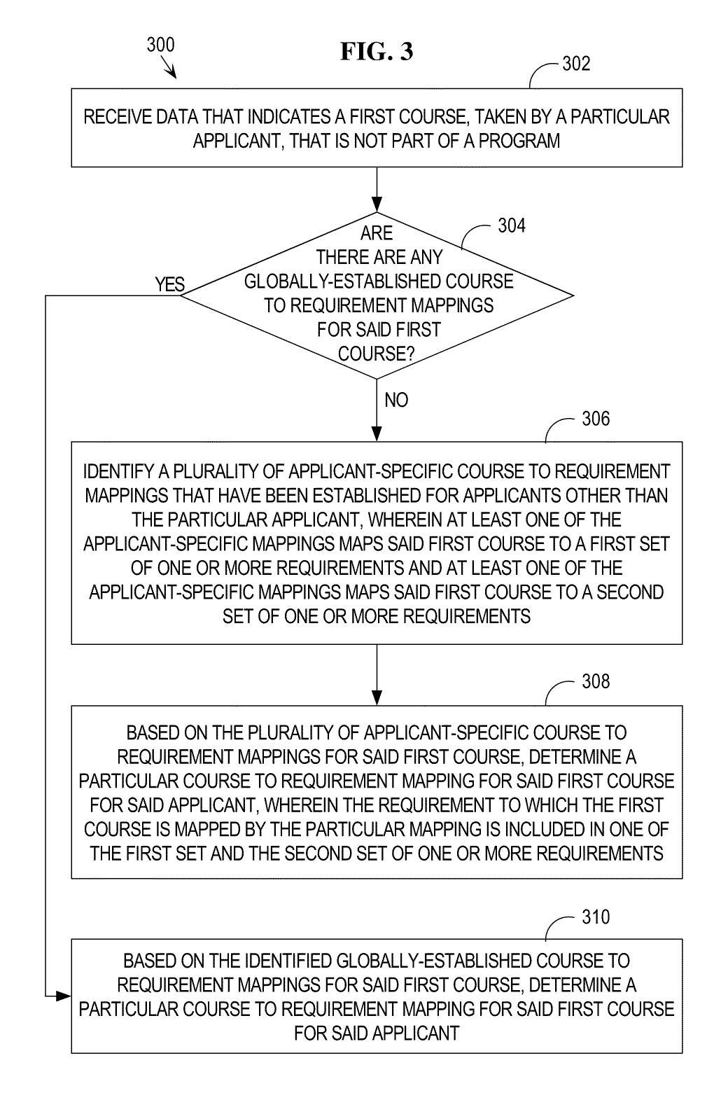

FIG. 3 illustrates an example method 300 of using previously-established course-to-requirement mappings to determine a mapping for a particular external course to one or more requirements of a particular internal program for a particular student. At step 302, data is received that indicates a first external that was taken by a particular applicant.

In one embodiment, the student manually enters information about institutions from which the student has taken courses, and about the particular courses that the student has completed. The institution and course information may be submitted to course evaluator 122 via network 130 by the student, who is a user of client device 110. The student may submit the information through a web page that the user requested from course evaluator 122 through browser 112.

In another embodiment, course evaluator 122 is communicatively connected to systems of other institutions. In this embodiment, a student inputs to course evaluator 122 the names of the institutions from which the student has taken courses. Course evaluator 122 automatically requests information about the courses that the student has taken from the indicated universities through the connections to the systems of the indicated institutions. For example, the institutions may use SOAP, or another communication protocol, to communicate information requests and course information responses between the respective systems. Thus, course evaluator 122 may retrieve information about external courses taken by a student without the student having to manually input the information for each course.

To illustrate step 302 of method 300, information about a course may be received at course evaluator 122, which evaluates courses that are external to a target institution. For ease of illustration, the target institution is described herein as Target University. However, any institution may be the target institution associated with course evaluator 122 within the embodiments of the invention. In this example, the external course information received by course evaluator 122 is information about Comm 172 offered by Source University. Comm 172 is not part of any program at Target University because the course is offered by a different institution than Target University.

At step 304, it is determined whether there are any global course-to-requirement mappings for said first course. For example, course evaluator 122 determines whether any global course-to-requirement mappings for Comm 172 offered by Source University are recorded in database 140, as illustrated in FIG. 2. Course evaluator 122 determines that Comm 172 offered by Source University is not globally mapped to any of the requirements of Target University, as illustrated by global mappings 210.

Based on the determination at step 304, method 300 continues to step 306. At step 306, a plurality of applicant-specific course-to-requirement mappings that have been established for applicants other than the particular applicant are identified, wherein at least one of the applicant-specific mappings maps said first course to a first set of one or more requirements and at least one of the applicant-specific mappings maps said first course to a second set of one or more requirements.

For example, course evaluator 122 identifies applicant-specific mappings 222, 224, and 226 in database 140 (FIG. 2) as applicant-specific course-to-requirement mappings that have been established for Comm 172 offered by Source University. Applicant-specific mapping 222 maps Comm 172 by Source University to Comm 102 offered by Target University; applicant-specific mapping 224 maps Comm 172 by Source University to Comm 200 offered by Target University; and applicant-specific mapping 226 maps Comm 172 by Source University to GEN 101 offered by Target University.

Step 306 indicates that at least one of the identified mappings maps the first course to a first set of one or more requirements and at least one of the mappings maps the first course to a second set of one or more requirements. In the example illustrated above, Comm 102 by Target University (mapping 222) may be considered the first set of one or more requirements and Comm 200 by Target University (mapping 224) may be considered the second set of one or more requirements. Furthermore, GEN 101 by Target University (mapping 226) may be considered a third set of one or more requirements. While the example only illustrates sets with a single requirement, a set of one or more requirements may include any number of requirements within the embodiments of the invention.

At step 308, a particular course-to-requirement mapping for said first course is determined for said applicant based on the plurality of applicant-specific course-to-requirement mappings for said first course, wherein the requirement to which the first course is mapped by the particular mapping is included in one of the first set and the second set of one or more requirements.

If database 140 does not include a mapping for a particular external course submitted to course evaluator 122 that fulfills a requirement of a program in which the student is interested, course evaluator 122 may indicate to the student that there is no logical mapping for the course, or may map the course to general or elective credits.

### Manual Applicant-Specific Course-to-Requirement Mappings

In one embodiment, the determination of a particular course-to-requirement mapping for the first course for a particular applicant is performed by a human evaluator based, at least in part, on generated applicant-specific course-to-requirement mappings that were previously generated for other applicants. Determining a mapping for the first course through a human evaluator may produce a mapping that is more reliable than a mapping that is automatically generated. Thus, an institution may use this embodiment when the determination of the mapping for the first course is to be binding on the institution.

In this embodiment, course evaluator 122 may automatically generate a display of the information about (a) the first course, and (b) the course-to-requirement mappings identified at step 306. Such a display may be in a web page, an email, etc. Based on the displayed information, the human evaluator may determine an appropriate course-to-requirement mapping for the first course for the applicant that submitted the information for the first course. Course evaluator 122 may receive the determined course-to-requirement mapping for the first course for the applicant and store the information in database 140.

For example, course evaluator 122 may receive a request from a human evaluator to display information about received external course evaluation requests. In response to the request, course evaluator 122 generates a display of the information about external course Comm 172 offered by Source University that was submitted by Student B. Course evaluator 122 also generates a display of information about applicant-specific mappings 222-226, which map Comm 172 by Source University to courses that are internal to Target University.

Based on the information about applicant-specific mappings 220, the human evaluator may map, for Student B, Comm 172 by Source University to one of Comm 102, Comm 200, and GEN 101 offered by Source University. The human evaluator may also map the external course to another internal requirement that is not included in a mapping in database 140. Information for the mapping established for Student B may be received by course evaluator 122 and included in database 140.

The display of information for the human evaluator may make a visual distinction between applicant-specific mappings stored in database 140 that are established for Student B and applicant-specific mappings that are established for other students. An evaluator may find an applicant-specific mapping that is already established for Student B for Comm 172 by Source University to be very pertinent to the determination of the mapping for the course for Student B.

### Automated Applicant-Specific Course-to-Requirement Mappings

In another embodiment, a course-to-requirement mapping is automatically determined for the course for the applicant by course evaluator 122. This automatic determination may be performed by any computing device that has access to the information in database 140. An institution may utilize automatic determination of a mapping for an external course to an internal requirement when the resulting mapping is not binding on the institution. Such a non-binding mapping may be performed for a “what-if” degree audit for students investigating transferring to an institution, who are not yet matriculating. A “what-if” degree audit gives a student an idea of how far along the student would be in a particular program at an institution to which the student may transfer.

Course evaluator 122 may automatically determine a mapping for the first course (“new applicant-specific mapping”) for Student B based on the applicant-specific mappings that have been previously established and recorded in database 140. In one embodiment, if course evaluator 122 determines that a particular applicant-specific mapping in database 140 was established for Student B, then course evaluator 122 applies the particular applicant-specific mapping to the coursework for Student B. For purposes of illustration, none of the applicant-specific mappings 220 in database 140 (FIG. 2) have been established for Student B.

### Automated Frequency-Based Selection of Mappings

In one embodiment, course evaluator 122 may establish the new applicant-specific mapping based, at least in part, on which applicant-specific mapping identified in step 306 occurs in database 140 the most frequently. As previously indicated, FIG. 2 illustrates database 140 in which 75% of the mappings of Comm 172 by Source University map the course to Comm 102 by Target University (mapping 222), 23% map the course to Comm 200 by Target University (mapping 224), and 2% map the course to GEN 101 by Target University (mapping 226). In this embodiment, course evaluator 122 establishes a mapping between Comm 172 from Source University and Comm 102 by Target University for Student B because this mapping has the highest occurrence percentage in database 140.

### Automated Program-Based Selection of Mappings

In another embodiment, course evaluator 122 establishes the new applicant-specific mapping for Student B based on the requirements of a particular program in which the student has indicated interest. A student may indicate interest in a particular program at the time that the student submits information about an external course to course evaluator 122.

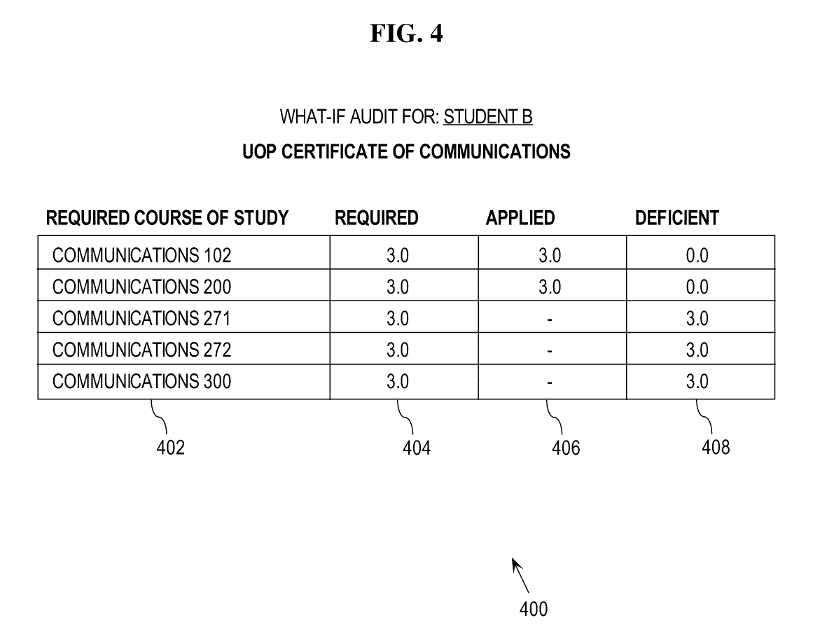

For example, a program to earn a Certificate of Communications at Target University requires taking and passing five Communications classes, listed in column 402 of Graphical User Interface (GUI) 400 of FIG. 4, described in more detail below. The list of courses required for the Certificate includes Comm 102 and Comm 200. In this example, the only external course information that Student B submits to course evaluator 122 is information for Comm 172 offered by Source University. In this case, course evaluator 122 may map Comm 172 by Source University to either of the Communications courses offered by Target University that are indicated in applicant-specific mappings 220 to the advantage of the student. Course evaluator 122 may choose to map Comm 172 by Source University to one of the communications courses using any heuristic, e.g., the course with the highest percentage. In this case, course evaluator 122 would not map Comm 172 to GEN 101, as indicated in mapping 226, because such a mapping would not fulfill a requirement for the program indicated by Student B.

Student B may submit multiple courses for evaluation to course evaluator 122. In one embodiment of the invention, course evaluator 122 bases the mapping for a first course that Student B submits on a mapping that course evaluator 122 establishes for a second course that Student B submits. For example, Student B has indicated interest in the program associated with the Certificate of Communications at Target University and submits information for two external courses to be mapped to program requirements. Course evaluator 122 determines that one of the external courses (not shown in database 140 of FIG. 2) may map only to Comm 102 by Target University. The other external course is Comm 172 by Source University. Based on the applicant-specific course-to-requirement mappings identified in step 306, course evaluator 122 may map Comm 172 by Source University to any one of Comm 102, Comm 200, and GEN 101 offered by Target University.

In this case, course evaluator 122 determines, based on the mapping of the other external course submitted by Student B to Comm 102 by Target University, that it would not be beneficial to the student to map Comm 172 by Source University to Comm 102 by Target University as well. Such a mapping would be redundant with the mapping of the other external course and would not facilitate Student B's progress in the selected program. Also, GEN 101 is not a requirement of the program indicated by Student B. Therefore, in this case, course evaluator 122 maps Comm 172 by Source University to Comm 200 by Target University, which course is included in the indicated program.

### Percentage-Threshold Based Selection of Mappings

In yet another embodiment, an external course submitted to course evaluator 122 may only be mapped to requirements that are associated with a percentage that is greater than a specified threshold. This embodiment prevents external courses from being mapped to outlier applicant-specific mappings in database 140. For example, if the specified threshold is 3%, then course evaluator 122 would not map Comm 172 by Source University to GEN 101 by Target University, even if the mapping would be beneficial to the student, because the percentage associated with GEN 101 in database 140 is less than 3%.

### Using Global Mappings to Determine a Mapping for an External Course

Returning to the description of method 300 (FIG. 3), at step 302, course evaluator 122 receives, from Student B, information about a first course, specifically, Comm 120 offered by Source University. At step 304, it is determined whether there are any global course-to-requirement mappings for said first course. For example, course evaluator 122 determines whether any global course-to-requirement mappings for Comm 120 offered by Source University are recorded in database 140 illustrated in FIG. 2. In this example, course evaluator 122 determines that Comm 120 offered by Source University is globally mapped to Comm 110 and to Comm 102 offered by Target University, as illustrated by global mappings 210.

Based on the determination at step 304, method 300 continues to step 310. At step 310, a particular course-to-requirement mapping for said first course for said applicant is determined based on the identified global course-to-requirement mappings for said first course.

Step 310 may be automatically performed at a computing device such as server device 120 (FIG. 1). For example, course evaluator 122 may automatically map Comm 120 by Source University to one of Comm 110 and Comm 102 by Target University, as indicated by the global mappings 210 identified at step 304. The decision of which internal course to map to the external course may be based on the requirements of a program in which Student B has indicated interest, as described above. In one embodiment, the mapping that is automatically established at step 310 is based on the identified global mappings, and no applicant-specific course-to-requirement mappings are considered. In another embodiment, course evaluator 122 identifies applicant-specific course-to-requirement mappings that have been previously established for Student B and bases the mappings on these applicant-specific mappings and the identified global mappings.

Furthermore, step 310 may also be performed by a human evaluator. In this embodiment, the human evaluator may establish a mapping for Student B based on a display of information about global mappings 210 that is generated by course evaluator 122, which generation is described above. Additionally, course evaluator 122 may generate a display of information about a plurality of applicant-specific course-to-requirement mappings, e.g., identified by course evaluator 122 performing the functions of step 306, as described above. Thus, the human evaluator may establish the mapping for said first course for said applicant based on information about globally-established and applicant-specific mappings.

### Display of the Results of Mapping External Courses to Internal Requirements

Once the courses submitted to course evaluator 122 have been mapped to the requirements of an internal program, course evaluator 122 may generate a display with information about the requirements to which the courses have been mapped. Such a display may be a web page and/or an email created by course evaluator 122 and transmitted to client device 110 over network 130.

Information about a student's progress, or projected progress, in a particular program may be stored in database 140 in conjunction with a login. Thus, the student may review the program progress, or revise information submitted to course evaluator 122, by logging into a web page. Such a login web page receives login information and retrieves any associated data from database 140 for display.

FIG. 4 illustrates an example GUI 400 to display Student B's progress in the program associated with a Certificate of Communications at Target University. The displayed information is based on course-to-requirement mappings that have been established for Student B's external coursework. GUI 400 displays all of the requirements for a Certificate of Communications from Target University in column 402. Column 404 indicates the number of credit hours that are associated with each course in column 402. Column 406 indicates that Comm 102 and Comm 200 are fulfilled based on course-to-requirement mappings that have been established for Student B in database 140. Column 408 indicates that Student B still needs to fulfill three course requirements for the program, specifically, Comm 271, Comm 272, and Comm 300. GUI 400 may also indicate any external courses taken by the student that were not applied to the displayed program requirements.

GUI 400 indicates that the information displayed therein is for a “what-if” audit. A GUI may include the label of a “what-if” audit, or the equivalent, if one or more of the course-to-requirement mappings on which the displayed information is based is a mapping that is not binding to the institution. Additionally, in the case of a “what-if” audit, GUI 400 may indicate more explicitly that the results of the audit are estimated and are contingent on further approval. If GUI 400 displays a student's progress in a program that is determined based on mappings that are binding to the institution, GUI 400 may indicate that the displayed progress in the program is not estimated.

GUI 400 may include other information about a program, such as the estimated total time to complete the program for a typical student, the estimated time for the particular student, e.g., Student B, to complete the program given the student's progress in the program, job placement statistics from the program, job opportunities available after completing the program, etc. Information about a student's progress in a program may be visually summarized using a graphic, such as a table or chart, which allows a student to quickly assess the student's overall progress in the program.

As described above, two or more mappings for a particular external course submitted by a student may map the external course to requirements for a particular program displayed in GUI 400 for the student. If course evaluator 122 has no other information about which mapping would be most useful for the student, then course evaluator 122 may automatically select either mapping for the particular external course, to the benefit of the student, based on any heuristic. Alternatively, course evaluator 122 may provide information on the potential mappings for the external course, e.g., through GUI 400, and allow the student to choose which mapping to apply to the particular external course. For example, if a student submits to course evaluator 122 information about an external course that may map to two or more requirements of a program in which the student has indicated interest, course evaluator 122 may generate a display to communicate the various mapping options to the student. The student may select one of the mappings, perhaps based on personal preference, to the student's best benefit. GUI 400 may reflect the consequences of the student's decision on the student's progress in a particular program.

### Automated Program Suggestions

Rather than determine how a student's external courses map to the requirements of a single program, the automated mapping techniques described herein may be performed repeatedly to map the student's external courses to each of multiple programs. In this manner, the student may select which program to pursue based, at least in part, on how the student's external courses would be applied in the various programs offered by the target institution.

In an embodiment that maps a student's external courses to the requirements of each of a plurality of programs, GUI 400 includes information about a student's progress in the multiple programs. Information about a student's progress in multiple programs offered by an institution may help the student to evaluate whether to transfer to the institution, and in which program to enroll. The student may explicitly request which programs to display in GUI 400, e.g., by choosing the programs to display from a list of programs displayed in GUI 400.

One or more of the programs displayed in GUI 400 may also be automatically selected by course evaluator 122 based on criteria provided by the student. For example, if a student indicates interest in a particular academic area or topic, such as Communications, then course evaluator 122 may display the student's progress in multiple programs associated with Communications, e.g., Certificate of Communications, Associate of Arts in Communications, and Bachelor of Science in Communication with a Concentration in Communication and Technology, etc.

Furthermore, a student may indicate interest in graduating within a certain amount of time, e.g., four years, two years, as little time as possible, etc. The amount of time may be a total amount of time estimated to complete a program, or the amount of time it would take the student to complete a program based on the course information that the student has submitted to course evaluator 122. Course evaluator 122 may include such time information in the determination of which programs to display in GUI 400.

For example, a student may indicate that the student is interested in studying (a) a Communications program, and (b) a program that would take her two years or less to complete. Course evaluator 122 would select, from the programs at Target University in the Communications field, only those programs that would take the student two years or less to complete given the external course information that the student has submitted. In another example, the student indicates that she would like to graduate in as little time as possible, and does not indicate a topic of interest. In this example, course evaluator 122 automatically determines mappings of the student's external courses to each program's requirements, and then displays a certain number of programs that would take the least amount of time for the student to complete given the information that the student has submitted.

### Use of Automated Applicant-Specific Mappings

GUI 400 may provide additional options to the student. For example, in the case of a “what-if” audit, GUI 400 may provide the student with an option to transfer the displayed information to an enrollment counselor to help the student enroll at the institution. The student may also be given an option to immediately apply to the institution based on the institution and course information that the student has submitted to course evaluator 122. If the student takes the option to immediately apply to the institution, the institution and course information that the student has provided to course evaluator 122 may be automatically imported into the application for admission to the new institution, to save time for the student.

Furthermore, in conjunction with the application process, the new institution may automatically request official transcripts of a student's coursework from the institutions associated with the external courses that the student has submitted to course evaluator 122. Also, GUI 400 may provide a live chat option to allow the student to communicate directly with a live chat operator from the institution. The live chat operator may have access to the institution and course information submitted by the student, as well as information on the student's progress in programs, as determined by course evaluator 122.

The information described herein as displayed in GUI 400 may be displayed in a single display, or multiple displays, which may or may not be interactive.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

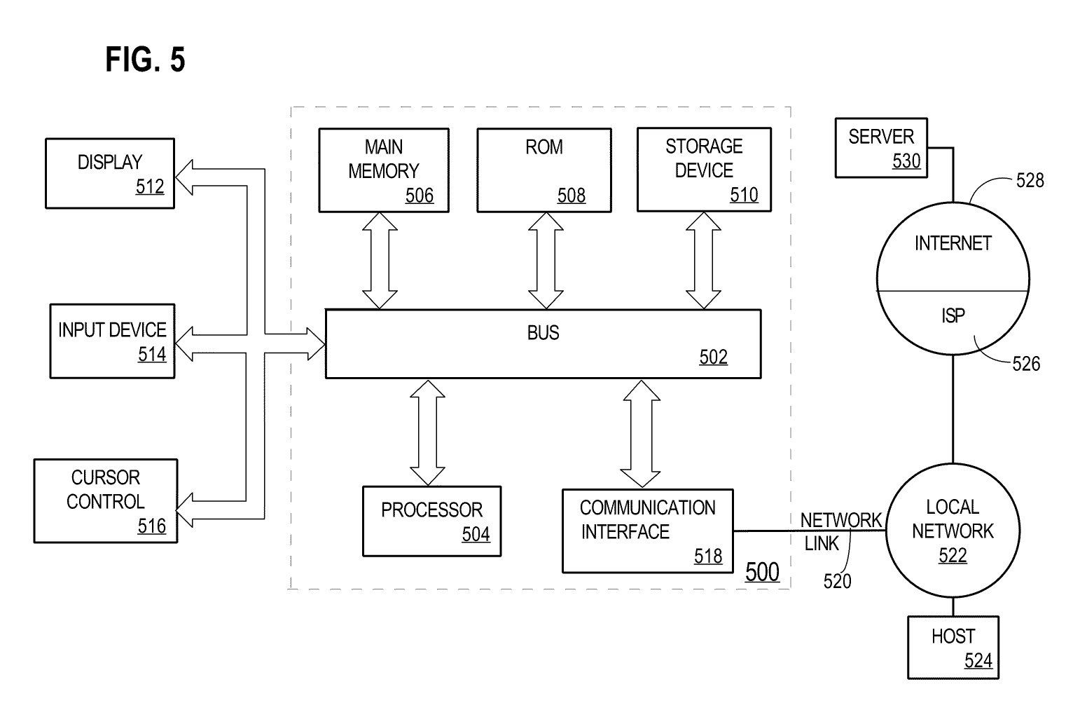

For example, FIG. 5 is a block diagram that illustrates a computer system 500 upon which an embodiment may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-executed method for determining which requirements of a program will be satisfied by a particular applicant that has taken courses that are not part of the program, comprising:
receiving data that indicates a first course, taken by the particular applicant, that is not part of the program;
identifying a plurality of applicant-specific course-to-requirement mappings that have been established for applicants other than the particular applicant;
wherein at least a first mapping of the plurality of applicant-specific course-to-requirement mappings maps said first course to a first set of one or more requirements;
wherein at least a second mapping of the plurality of applicant-specific course-to-requirement mappings maps said first course to a second set of one or more requirements,
wherein the first set of one or more requirements is different than the second set of one or more requirements;
based at least in part on the plurality of applicant-specific course-to-requirement mappings for said first course, determining a particular course-to-requirement mapping for said first course for said particular applicant;
wherein the particular course-to-requirement mapping maps the first course to a third set of one or more requirements;
wherein the third set of one or more requirements is included in at least one of: the first set of one or more requirements, and the second set of one or more requirements; and
wherein the steps of receiving data that indicates said first course and identifying said plurality of applicant-specific course-to-requirement mappings are performed by one or more computing devices.

2. The computer-executed method of claim 1 further comprising:
determining whether there are any global course-to-requirement mappings for said first course; and
wherein the particular course-to-requirement mapping for said first course for said particular applicant is determined based on the plurality of applicant-specific course-to-requirement mappings in response to determining that there are no global course-to-requirement mappings for said first course.

3. The computer-executed method of claim 1, wherein the step of determining said particular course-to-requirement mapping for said first course for said particular applicant further comprises automatically determining said particular course-to-requirement mapping.

4. The computer-executed method of claim 1, further comprising:
receiving data that indicates a second course, taken by the particular applicant, that is not part of the program;
identifying a course-to-requirement mapping for the second course; and
determining said particular course-to-requirement mapping for said first course for said particular applicant based at least in part on the course-to-requirement mapping identified for the particular applicant for the second course.

5. The computer-executed method of claim 1, wherein the step of determining said particular course-to-requirement mapping for said first course for said particular applicant further comprises determining said particular course-to-requirement mapping based at least in part on how frequently the first course was mapped to the third set of one or more requirements within the plurality of applicant-specific course-to-requirement mappings.

6. The computer-executed method of claim 1, further comprising:
determining that a third mapping of the plurality of applicant-specific course-to-requirement mappings is associated with a percentage that is less than a specified threshold;
in response to determining that the third mapping is associated with a percentage that is less than the specified threshold, excluding the third mapping from consideration in the step of determining the particular course-to-requirement mapping for said first course for said particular applicant.

7. The computer-executed method of claim 1, wherein:
a course-to-requirement mapping maps a course that is not part of the program with a requirement of the program;
a course comprises a qualification that may be mapped to a requirement of the program, comprising one of:
(a) a class for which credit is granted at an institution other than a target institution associated with the program,
(b) a proficiency exam,
(c) a professional license, and
(d) a published experiential essay; and
a requirement comprises one of:
(a) a particular course offered by the target institution,
(b) course credit for a particular category of courses for the target institution,
(c) general course credit, and
(d) a non-course requirement of the program.

8. The computer-executed method of claim 1, wherein:
the program is associated with a target institution;
the course-to-requirement mappings are mappings established for the program; and
the first course is a course for an institution other than the target institution.

9. The computer-executed method of claim 1, wherein an applicant-specific course-to-requirement mapping is established for an individual applicant, and is not applied to other applicants to the program.

10. The computer-executed method of claim 1, wherein each of the mappings of the plurality of applicant-specific course-to-requirement mappings for said first course has been the basis for transfer of an applicant other than said particular applicant.

11. The computer-executed method of claim 1, wherein the step of receiving data that indicates said first course further comprises receiving the data that indicates said first course directly from an institution associated with said first course.

12. The computer-executed method of claim 1, wherein said particular course-to-requirement mapping maps the first course to a particular requirement associated with said program, further comprising:
generating a display of the requirements of said program;
wherein said display indicates that the particular requirement of said program is fulfilled based on said particular course-to-requirement mapping.

13. The computer-executed method of claim 12, wherein said display includes information about at least one of:
(a) an estimated total time to complete said program for a typical student; or
(b) an estimated time for the particular applicant to complete said program based, at least in part, on the particular course-to-requirement mapping.

14. The computer-executed method of claim 12, wherein:
said display includes a display of the requirements of a second program;
the second program is selected by the particular applicant; and
the display further indicates how said first course maps to requirements of the second program.

15. The computer-executed method of claim 12, further comprising:
receiving program criteria submitted by the particular applicant;
wherein said program criteria includes information indicating (a) an area of interest, and (b) a period of time; and
automatically selecting a second program based, at least in part, on said program criteria;
wherein said display includes a display of how the first course maps to the requirements of said second program.

16. The computer-executed method of claim 15, wherein the period of time is indicated as the shortest possible amount of time to finish any program offered by a target institution.

17. The computer-executed method of claim 12, wherein said display includes a control that represents an option to apply to a first institution associated with the program based, at least in part, on the data that indicates said first course, further comprising:
in response to a user activating the control:
automatically inserting the data that indicates said first course into an application to the first institution; and
automatically requesting transcripts from a second institution associated with said first course for use in applying to the first institution.

18. A computer-readable storage medium that stores instructions which, when executed by one or more processors, cause the one of more processors to perform the steps of:
receiving data that indicates a first course, taken by the particular applicant, that is not part of the program;
identifying a plurality of applicant-specific course-to-requirement mappings that have been established for applicants other than the particular applicant;
wherein at least a first mapping of the plurality of applicant-specific course-to-requirement mappings maps said first course to a first set of one or more requirements;
wherein at least a second mapping of the plurality of applicant-specific course-to-requirement mappings maps said first course to a second set of one or more requirements,
wherein the first set of one or more requirements is different than the second set of one or more requirements;
based at least in part on the plurality of applicant-specific course-to-requirement mappings for said first course, determining a particular course-to-requirement mapping for said first course for said particular applicant;
wherein the particular course-to-requirement mapping maps the first course to a third set of one or more requirements;
wherein the third set of one or more requirements is included in at least one of:
the first set of one or more requirements, and
the second set of one or more requirements; and
wherein the steps of receiving data that indicates said first course and identifying said plurality of applicant-specific course-to-requirement mappings are performed by one or more computing devices.

19. The computer-readable storage medium of claim 18 further comprising instructions for:
determining whether there are any global course-to-requirement mappings for said first course; and
wherein the particular course-to-requirement mapping for said first course for said particular applicant is determined based on the plurality of applicant-specific course-to-requirement mappings in response to determining that there are no global course-to-requirement mappings for said first course.

20. The computer-readable storage medium of claim 18, wherein the step of determining said particular course-to-requirement mapping for said first course for said particular applicant further comprises automatically determining said particular course-to-requirement mapping.

21. The computer-readable storage medium of claim 18, further comprising instructions for:
receiving data that indicates a second course, taken by the particular applicant, that is not part of the program;
identifying a course-to-requirement mapping for the second course; and
determining said particular course-to-requirement mapping for said first course for said particular applicant based at least in part on the course-to-requirement mapping identified for the particular applicant for the second course.

22. The computer-readable storage medium of claim 18, wherein the step of determining said particular course-to-requirement mapping for said first course for said particular applicant further comprises determining said particular course-to-requirement mapping based at least in part on how frequently the first course was mapped to the third set of one or more requirements within the plurality of applicant-specific course-to-requirement mappings.

23. The computer-readable storage medium of claim 18, further comprising instructions for:
determining that a third mapping of the plurality of applicant-specific course-to-requirement mappings is associated with a percentage that is less than a specified threshold;
in response to determining that the third mapping is associated with a percentage that is less than the specified threshold, excluding the third mapping from consideration in the step of determining the particular course-to-requirement mapping for said first course for said particular applicant.

24. The computer-readable storage medium of claim 18, wherein:
a course-to-requirement mapping maps a course that is not part of the program with a requirement of the program;
a course comprises a qualification that may be mapped to a requirement of the program, comprising one of:
(a) a class for which credit is granted at an institution other than a target institution associated with the program,
(b) a proficiency exam,
(c) a professional license, and
(d) a published experiential essay; and
a requirement comprises one of:
(a) a particular course offered by the target institution,
(b) course credit for a particular category of courses for the target institution,
(c) general course credit, and
(d) a non-course requirement of the program.

25. The computer-readable storage medium of claim 18, wherein:
the program is associated with a target institution;
the course-to-requirement mappings are mappings established for the program; and
the first course is a course for an institution other than the target institution.

26. The computer-readable storage medium of claim 18, wherein an applicant-specific course-to-requirement mapping is established for an individual applicant, and is not applied to other applicants to the program.

27. The computer-readable storage medium of claim 18, wherein each of the mappings of the plurality of applicant-specific course-to-requirement mappings for said first course has been the basis for transfer of an applicant other than said particular applicant.

28. The computer-readable storage medium of claim 18, wherein the step of receiving data that indicates said first course further comprises receiving the data that indicates said first course directly from an institution associated with said first course.

29. The computer-readable storage medium of claim 18, wherein said particular course-to-requirement mapping maps the first course to a particular requirement associated with said program, further comprising instructions for:
generating a display of the requirements of said program;
wherein said display indicates that the particular requirement of said program is fulfilled based on said particular course-to-requirement mapping.

30. The computer-readable storage medium of claim 29, wherein said display includes information about at least one of:
(a) an estimated total time to complete said program for a typical student; or
(b) an estimated time for the particular applicant to complete said program based, at least in part, on the particular course-to-requirement mapping.

31. The computer-readable storage medium of claim 29, wherein:
said display includes a display of the requirements of a second program;
the second program is selected by the particular applicant; and
the display further indicates how said first course maps to requirements of the second program.

32. The computer-readable storage medium of claim 29, further comprising instructions for:
receiving program criteria submitted by the particular applicant;
wherein said program criteria includes information indicating (a) an area of interest, and (b) a period of time; and
automatically selecting a second program based, at least in part, on said program criteria;
wherein said display includes a display of how the first course maps to the requirements of said second program.

33. The computer-readable storage medium of claim 32, wherein the period of time is indicated as the shortest possible amount of time to finish any program offered by a target institution.

34. The computer-readable storage medium of claim 29, wherein said display includes a control that represents an option to apply to a first institution associated with the program based, at least in part, on the data that indicates said first course, further comprising instructions for:
in response to a user activating the control:
automatically inserting the data that indicates said first course into an application to the first institution; and
automatically requesting transcripts from a second institution associated with said first course for use in applying to the first institution.
